(19) United States
(12) Patent Application Publication
(10) Pub. No.: US 2026/0188943 A1
(43) Pub. Date: Jul. 2, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tomohiro HAYASHI, Mie (JP); Yusuke YAMADA, Mie (JP); Takato MIZUNO, Mie (JP); Katsuhiko AIZAWA, Mie (JP)

(21) Appl. No.: 18/866,072

(22) PCT Filed: May 10, 2023
(86) PCT No.: PCT/JP2023/017563

§ 371 Date: Nov. 15, 2024

(30) Foreign Application Priority Data
May 18, 2022 (JP) 2022-081504

(51) Int. Cl. H01R 13/58; H01R 12/77; H01R 13/512; H01R 13/52; H01R 13/6581

(52) U.S. Cl. CPC H01R 13/5812; H01R 12/778; H01R 13/512; H01R 13/5205; H01R 13/6581; H01R 2201/26

(57) ABSTRACT

A connector includes a connector housing, a wire projecting out from the connector housing, a wire holding portion integrally including a body portion for holding a projecting part of the wire and a bolt insertion tube portion made of metal extending through the body portion, a shield shell made of metal for covering the connector housing, and a pressing portion made of metal to be fastened to the shield shell by a bolt inserted into the bolt insertion tube portion while sandwiching the wire holding portion between the shield shell and the pressing portion. The bolt insertion tube portion includes a projecting end part projecting from the body portion, and the body portion is spaced apart from the shield shell or the pressing portion across a gap by the projecting end part contacting the shield shell or the pressing portion.

### TECHNICAL FIELD

The present disclosure relates to a connector.

### BACKGROUND

Conventionally, a connector is used to electrically connect in-vehicle devices. Such a connector includes a connector housing, a terminal accommodated in the connector housing and a wire connected to the terminal, and the wire is pulled out to outside through a wire pull-out opening of the connector housing. Since an external force such as vibration on a vehicle is applied to the wire pulled out to outside, if the external force applied to the wire is transferred toward the terminal, stress may be applied to a contact point between the terminal and a mating terminal and problems such as contact wear may occur. Accordingly, the connector is required to have so-called external force blocking performance for suppressing the transfer of the external force applied to the wire toward the terminal. Thus, a connector disclosed in Patent Document 1 is provided with a rear holder made of resin and to be assembled with a connector housing while holding a wire.

### PRIOR ART DOCUMENT

### Patent Document

Patent Document 1: JP 2011-054393 A

### SUMMARY OF THE INVENTION

### Problems to be Solved

However, in Patent Document 1, the rear holder is assembled by the engagement of a locking portion in the form of a locking claw provided on the tip of a resilient projecting piece provided on the connector housing with an engaged portion provided on the rear holder when the locking portion rides over the engaged portion and resiliently returns while being resiliently deformed. Thus, the formation of a tiny gap between the locking portion and the engaged portion is unavoidable and an external force transferred to the wire may be transferred toward the terminal due to rattling caused by this gap. Further, since any of the locking portion, the engaged portion and the rear holder for holding the wire is made of resin, a gap may be further formed due to a creep phenomenon of the resin under a high temperature environment and the external force blocking performance of the connector may be further deteriorated.

Accordingly, a connector is disclosed which can improve a wire holding force and stably maintain external force blocking performance.

### Means to Solve the Problem

The present disclosure is directed to a connector with a connector housing including a wire pull-out opening, a wire to be connected to a terminal accommodated in the connector housing, the wire being pulled out to outside of the connector housing through the wire pull-out opening, a wire holding portion integrally including a body portion made of synthetic resin for holding a projecting part of the wire projecting out from the wire pull-out opening and a bolt insertion tube portion made of metal extending through the body portion in a first direction intersecting an axial direction of the wire, a shield shell made of metal for covering the connector housing by being fixed to the connector housing, and a pressing portion made of metal to be fastened to the shield shell by a bolt inserted into the bolt insertion tube portion while sandwiching the wire holding portion between the shield shell and the pressing portion in the first direction, the bolt insertion tube portion including a projecting end part projecting from the body portion at least on one side in the first direction, the body portion being spaced apart from the shield shell or the pressing portion across a gap by the projecting end part contacting the shield shell or the pressing portion.

### Effect of the Invention

According to the connector of the present disclosure, it is possible to improve a wire holding force and stably maintain external force blocking performance.

### BRIEF DESCRIPTION OF THE DRAWINGS

FIG. 1 is a perspective view of a connector according to one embodiment.

FIG. 2 is a bottom view of the connector shown in FIG. 1.

FIG. 3 is a vertical section enlargedly showing an essential part of a cross-section along III-III in FIG. 2.

FIG. 4 is a vertical section enlargedly showing an essential part of a cross-section along IV-IV in FIG. 2.

FIG. 5 is a vertical section enlargedly showing a cross-section along V-V in FIG. 2.

FIG. 6 is an exploded perspective view of the connector shown in FIG. 1.

FIG. 7 is an exploded perspective view of the connector shown in FIG. 1 when viewed from a bottom surface side.

FIG. 8 is a perspective view showing a state where a first holding portion constituting the connector shown in FIG. 1 is provided with bolt insertion tube portions.

FIG. 9 is a perspective view showing the first holding portion shown in FIG. 8 provided with the bolt insertion tube portions when viewed from the bottom surface side.

FIG. 10 is a perspective view showing a shield shell constituting the connector shown in FIG. 1.

FIG. 11 is a vertical section, corresponding to FIG. 5, showing a connector according to another mode.

### DETAILED DESCRIPTION TO EXECUTE THE INVENTION

### Description of Embodiments of Present Disclosure

First, embodiments of the present disclosure are listed and described.

The connector of the present disclosure is a connector with a connector housing including a wire pull-out opening, a wire to be connected to a terminal accommodated in the connector housing, the wire being pulled out to outside of the connector housing through the wire pull-out opening, a wire holding portion integrally including a body portion made of synthetic resin for holding a projecting part of the wire projecting out from the wire pull-out opening and a bolt insertion tube portion made of metal extending through the body portion in a first direction intersecting an axial direction of the wire, a shield shell made of metal for covering the connector housing by being fixed to the connector housing, and a pressing portion made of metal to be fastened to the shield shell by a bolt inserted into the bolt insertion tube portion while sandwiching the wire holding portion between the shield shell and the pressing portion in the first direction, the bolt insertion tube portion including a projecting end part projecting from the body portion at least on one side in the first direction, the body portion being spaced apart from the shield shell or the pressing portion across a gap by the projecting end part contacting the shield shell or the pressing portion.

According to this configuration, the projecting part of the wire projecting out from the wire pull-out opening of the connector housing is held by the synthetic-resin made body portion of the wire holding portion. This wire holding portion integrally includes the bolt insertion tube portion made of metal extending through the body portion in the first direction intersecting the axial direction of the wire. Further, the connector housing includes the shield shell made of metal for covering the connector housing by being fixed to the connector housing and the pressing portion arranged to face the shield shell in the first direction, the pressing portion is fastened to the shield shell by the bolt inserted into the bolt insertion tube portion of the wire holding portion with the wire holding portion sandwiched between the shield shell and the pressing portion. Here, the bolt insertion tube portion of the wire holding portion includes the projecting end part projecting from the body portion at least on the one side in the first direction, and the projecting end part is in contact with the shield shell or the pressing portion. Thus, the wire holding portion holding the wire in the body portion can be stably sandwiched between the shield shell and the pressing portion by an axial force of the bolt with the projecting end part of the bolt insertion tube portion made of metal held in direct contact with at least the shield shell or the pressing portion. As a result, the wire holding portion holding the wire can be reliably sandwiched between the shield shell and the pressing portion in the bolt insertion tube portion and a wire holding force can be improved as compared to the case where rattling due to a gap in a bonding structure itself of a rear holder for holding the wire is unavoidable as in a conventional structure.

In addition, since the gap is formed between facing surfaces of the body portion of the wire holding portion and the shield shell or the pressing portion on the side where the projecting end part of the bolt insertion tube portion projects from the body portion, the expansion of the body portion made of synthetic resin under a high temperature environment can be absorbed by this gap. As a result, it is possible to prevent the occurrence of troubles such as the deterioration of external force blocking performance caused when the expanded resin of the wire holding portion bites into a coating of the wire at high temperatures, the coating does not return from a pressed shape due to a creep phenomenon and a gap is formed between the coating and the wire holding portion. Therefore, the deterioration of the wire holding force due to a high temperature use environment can be suppressed or prevented, and the external force blocking performance of the connector can be stably maintained.

Preferably, the bolt insertion tube portion includes a pair of the projecting end parts projecting from the body portion on both sides in the first direction, and the body portion is spaced apart from the shield shell and the pressing portion across the gaps by the pair of projecting end parts contacting the shield shell and the pressing portion.

The bolt insertion tube portion of the wire holding portion includes the pair of projecting end parts projecting from the body portion on the both sides in the first direction, and the pair of projecting end parts are respectively in contact with the shield shell and the pressing portion. Therefore, the wire holding portion holding the wire in the body portion can be stably sandwiched between the shield shell and the pressing portion by the axial force of the bolt with the projecting end parts of the bolt insertion tube portion made of metal held in direct contact with the shield shell or pressing portion. As a result, the wire holding portion holding the wire can be more reliably sandwiched between the shield shell and the pressing portion in the bolt insertion tube portion, and the wire holding force can be further improved.

In addition, since the body portion of the wire holding portion is spaced apart from the facing surfaces of both the shield shell and the pressing portion across the gaps, the expansion of the body portion made of synthetic resin under the high temperature environment can be further absorbed and a pressing force for the coating of the wire and a creeping risk of the coating can be further reduced.

Preferably, the projecting end part of the bolt insertion tube portion projects with a projecting dimension of 0.5 mm or more from the body portion in the first direction. By setting the projecting dimension of the projecting end part from the body portion in the first direction to 0.5 mm or more, the resin expansion of the body portion at high temperatures can be advantageously absorbed and the pressing force applied to the coating of the wire and the creeping risk can be advantageously reduced. Note that, the projecting dimension is more preferably 0.6 mm or more, but an excessive gap is unnecessary to avoid enlargement.

Preferably, the body portion of the wire holding portion includes a first holding portion and a second holding portion constituting the body portion by being assembled with each other while sandwiching and holding the wire from the both sides in the first direction, a first recess to be held in contact with an outer peripheral surface of the wire by accommodating the wire is open in a contact surface of the first holding portion with the second holding portion, a second recess to be held in contact with the outer peripheral surface of the wire by accommodating the wire is open in a contact surface of the second holding portion with the first holding portion, the first and second recesses are connected to configure a wire through hole when the first and second holding portions are assembled, the first holding portion includes a first bolt insertion tube portion penetrating through the first holding portion in the first direction and having a pair of the projecting end parts projecting on both sides in the first direction, the second holding portion includes a second bolt insertion tube portion penetrating through the second holding portion in the first direction and having a pair of the projecting end parts projecting on both sides in the first direction, and the pressing portion, the first bolt insertion tube portion, the second bolt insertion tube portion and the shield shell are successively overlapped in the first direction and fastened by the bolt.

The body portion of the wire holding portion is divided into the first and second holding portions to be assembled from the both sides in the first direction, and the first recess of the first holding portion and the second recess of the second holding portion are connected to form the wire through hole only by assembling the first and second holding portions with the wire sandwiched therebetween. Thus, the wire holding portion can be easily mounted on the wire pulled out to outside from the connector housing. Moreover, each of the first and second holding portions obtained by division respectively include the first bolt insertion tube portion and the second bolt insertion tube portion penetrating and projecting in the first direction, and the pressing portion, the first bolt insertion tube portion, the second bolt insertion tube portion and the shield shell are successively overlapped in the first direction and fastened by the bolt. Therefore, the assemblability of the wire holding portion with the wire can be improved while firm retention of the wire holding portion is ensured.

Preferably, the gap between the body portion and the shield shell or the pressing portion in the first direction is determined by Equation 1 below:

$$gap > ( a \times ( t 1 - t 2 ) \times c ) + ( b \times ( t 1 - t 2 ) \times d ) , \qquad ( Equation 1 )$$

in (Equation 1), a denotes a plate thickness of the first or second holding portion in the first direction, b denotes a plate thickness of the pressing portion or the shield shell in a part in contact with the first or second holding portion in the first direction, c denotes a linear expansion coefficient of a material of the first or second holding portion, d denotes a linear expansion coefficient of a material of the pressing portion or the shield shell, t1 denotes a heat resistant temperature of the coating of the wire, and t2 denotes a normal temperature (in a range of 5° C. to 35° C.).

By setting the gap in the first direction between the facing surfaces of the body portion and the shield shell or the body portion and the pressing portion to satisfy Equation 1, the resin expansion of the body portion at high temperatures can be advantageously absorbed and the pressing force applied to the coating of the wire and the creeping risk can be advantageously reduced. Note that an excessive gap is unnecessary to avoid enlargement.

Preferably, the first recess of the first holding portion and the second recess of the second holding portion further extend in a projecting direction of the wire from the wire pull-out opening beyond the first and second bolt insertion tube portions, and one and the other of the first and second holding portions on extending end sides of the first and second recesses are respectively provided with a resilient lock piece and a lock claw portion for coupling the first and second holding portions. The first and second holding portions are coupled to each other by fitting and locking the resilient lock piece and the lock claw portion in a part spaced apart in the projecting direction of the wire from the first and second bolt insertion tube portions where the wire holding portion is bolt-fastened between the shield shell and the pressing portion. In this way, the transfer of an external force to the wire can be more advantageously suppressed. Further, the first and second holding portions can be temporarily held in a state sandwiching the wire therebetween in a state before bolt fastening, and the assemblability of the connector can be improved.

Preferably, at least one of the first and second recesses is provided with wire pressing ribs at a plurality of positions spaced apart from each other in a circumferential direction. Since the plurality of wire pressing ribs arranged apart from each other in the circumferential direction are provided in at least one of the first and second recesses, a displacement of the wire, e.g. a displacement in the circumferential direction, can be advantageously suppressed by the biting of the wire pressing ribs into the coating of the wire. Further, since the wire pressing ribs are spaced apart in the circumferential direction, the deformation of the coating of the wire can be advantageously allowed and the biting of the wire pressing ribs into the coating can be advantageously realized. Note that the wire pressing ribs are desirably provided at equal intervals in the circumferential direction in both the first and second recesses. This is because stress is distributed and the wire can be more stably held in this way.

Preferably, at least one of the first and second recesses is provided with the plurality of wire pressing ribs provided at the plurality of positions spaced apart from each other in the circumferential direction and distributed at two positions spaced apart from each other in the axial direction of the wire. This is because a displacement of the wire in the axial direction can also be advantageously suppressed and more stable holding of the wire can be realized since the plurality of wire pressing ribs arranged apart from each other in the circumferential direction are distributed at the two positions spaced apart from each other in the axial direction of the wire.

Preferably, a waterproof member for preventing water intrusion into the connector housing is externally fit on the wire, and the wire holding portion has a retainer function of hindering separation of the waterproof member to outside. If the connector includes the waterproof member, the wire holding portion can have a function as a retainer for the waterproof member, utilizing a strong fixing force for fixing the wire holding portion between the shield shell and the pressing portion. In this way, high functionality of the connector can be ensured with a small number of components.

### Details of Embodiment of Present Disclosure

A specific example of a connector of the present disclosure is described with reference to the drawings. Note that the present disclosure is not limited to these illustrations, but is represented by claims and intended to include all changes in the scope of claims and in the meaning and scope of equivalents.

### Embodiment

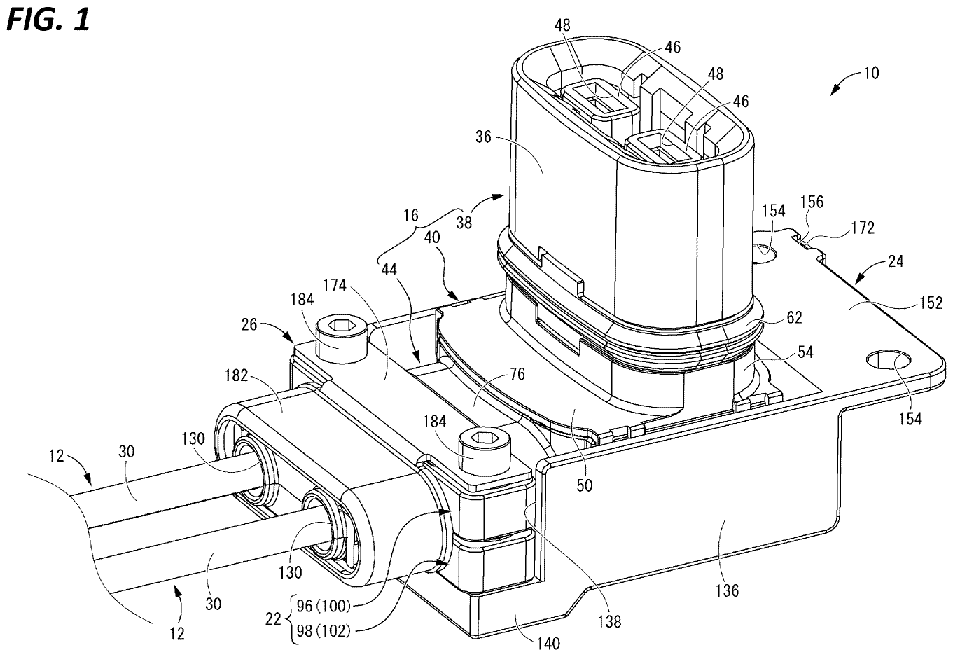

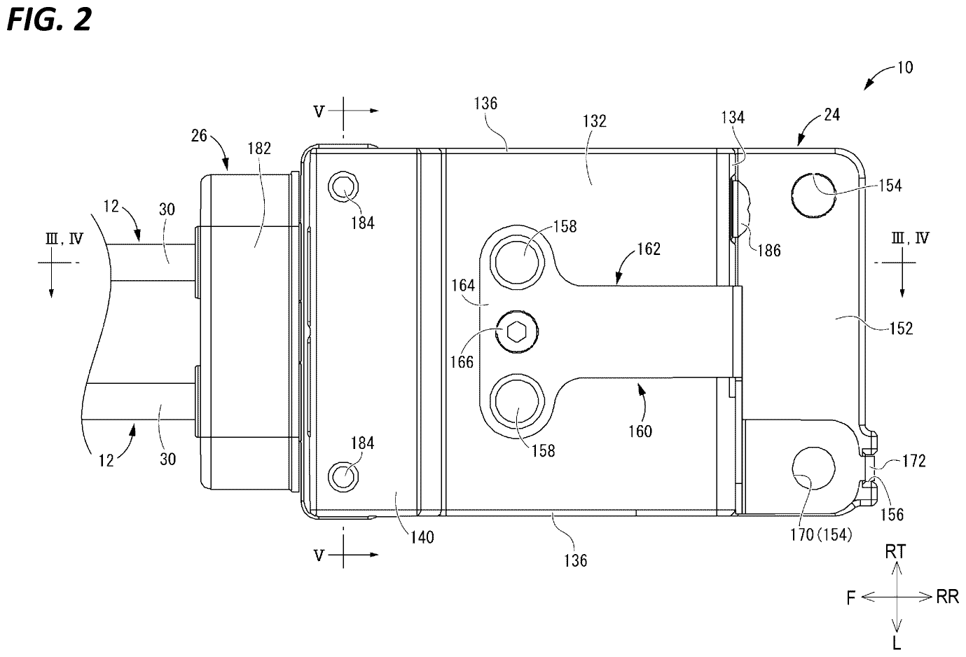

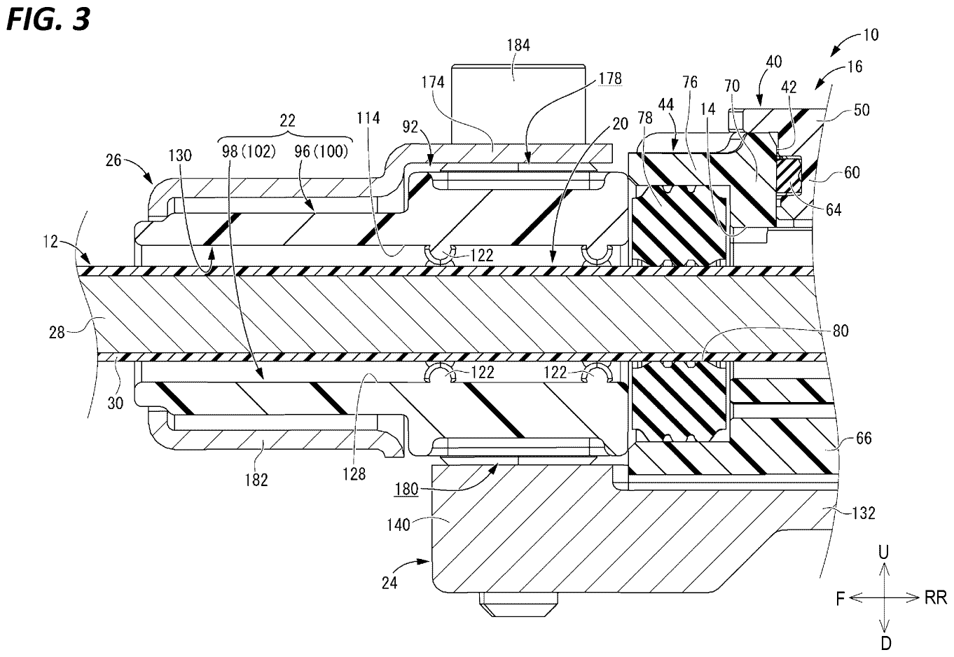

Hereinafter, a connector 10 of one embodiment of the present disclosure is described using FIGS. 1 to 10. The connector 10 is for electrically connecting in-vehicle devices, an in-vehicle device is electrically connected to wires 12 extending in a direction toward a left lower side in FIG. 1, and terminals of an unillustrated mating in-vehicle device are electrically connected from above in FIG. 1. Note that the connector 10 can be arranged in an arbitrary orientation, but upper and lower sides are upper and lower sides in FIG. 3, front and rear sides are left and right sides in FIG. 2, and left and right sides are lower and upper sides in FIG. 2 in the following description. Further, for a plurality of identical members, only some members may be denoted by a reference sign and the other members may not be denoted by the reference sign.

### (Connector 10)

The connector 10 of this embodiment includes a connector housing 16 having wire pull-out openings 14, and terminals 18 accommodated in the connector housing 16. The wires 12 are connected to the terminals 18 and pulled out to the outside of the connector housing 16 through the wire pull-out openings 14. Further, the connector 10 includes a wire holding portion 22 for holding projecting parts 20 of the wires 12 from the connector housing 16, a shield shell 24 made of metal for covering the connector housing 16 by being fixed to the connector housing 16 and a pressing portion 26 made of metal and to be bolt-fastened to the shield shell 24 while sandwiching the wire holding portion 22 between the shield shell 24 and the pressing portion 26. Note that, in this embodiment, a pair of the terminals 18, 18 and a pair of the wires 12, 12 are provided, and each wire 12 is connected to each terminal 18.

### (Wires 12)

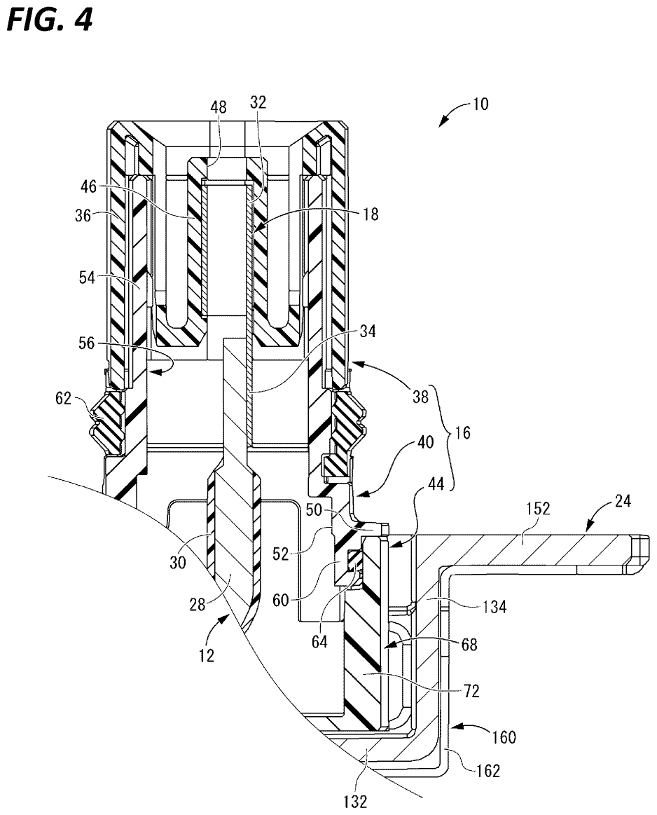

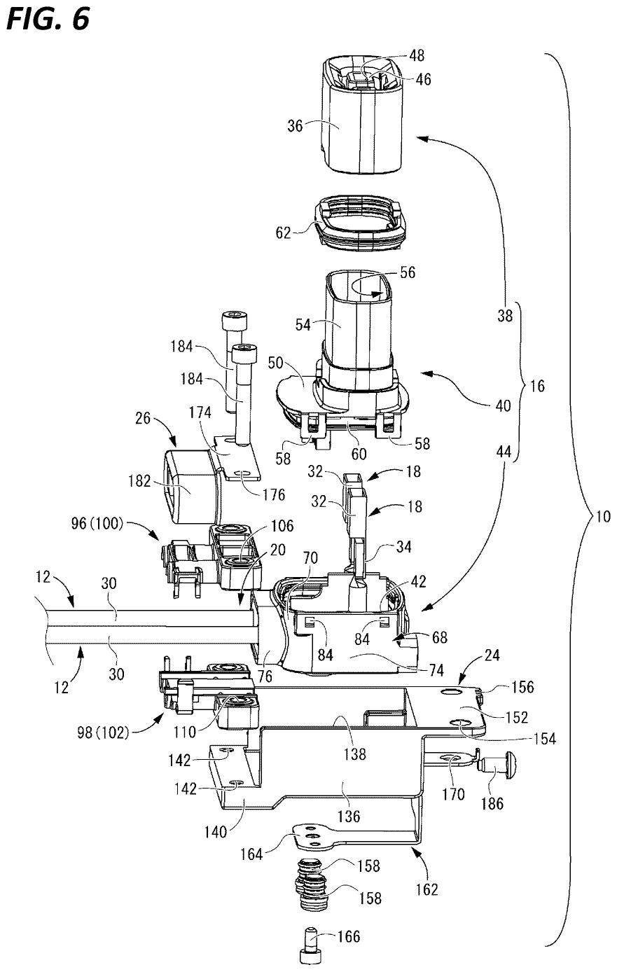

As also shown in FIG. 3 and the like, the wire 12 is a coated wire. That is, the wire 12 is configured by covering around a core wire 28 by an insulation coating 30 made of synthetic resin. As also shown in FIGS. 4 and 6, each wire 12 extends in a front-rear direction as a whole and is curved upward in a rear end part in this embodiment. In the rear end part (upper end part) of the wire 12, the insulation coating 30 is stripped to expose the core wire 28. By fixing the terminal 18 to this exposed core wire 28 by welding or the like, the wire 12 is electrically connected to the terminal 18.

### (Terminals 18)

The terminal 18 is made of metal and includes a substantially tubular contact point portion 32 open in a vertical direction. The tab-like terminal of the mating in-vehicle device is inserted into this contact point portion 32 and the contact point portion 32 and the mating terminal contact each other, whereby each terminal 18 of the connector 10 and the terminal of the mating in-vehicle device are electrically connected. A lower end part of each contact point portion 32 is provided with a part in the shape of a flat plate extending in the vertical direction. This part formed into a flat plate shape is a wire connecting portion 34 and fixed to the exposed core wire 28 in the upper end part of each wire 12.

### (Connector Housing 16)

The connector housing 16 is made of insulating synthetic resin. As also shown in FIG. 6 and the like, the connector housing 16 of this embodiment is composed of a plurality of members and is provided with a tubular housing 38 including a substantially tubular peripheral wall 36, an upper housing 40 to be assembled with the tubular housing 38 and a lower housing 44 including an upper opening 42 to be covered by the upper housing 40.

As also shown in FIG. 4, the tubular housing 38 includes holding tube portions 46 substantially in the form of rectangular tubes extending in the vertical direction on an inner peripheral side of the peripheral wall 36, and the contact point portions 32 of the terminals 18 are inserted and held in the holding tube portions 46 when the connector 10 is assembled. Since the pair of terminals 18, 18 are provided in this embodiment, a pair of the holding tube portions 46, 46 are provided side by side in a lateral direction in the tubular housing 38. Since the terminal of the mating in-vehicle device is assembled with the contact point portion 32 held in this holding tube portion 46 from above, an upper opening of the holding tube portion 46 is a terminal assembly opening 48, through which the mating terminal is assembled.

Note that unillustrated substantially frame-like engaging frame bodies are provided on both sides in the front-rear direction on the inner peripheral surface of the peripheral wall 36, and these engaging frame bodies are engaged with unillustrated engaging protrusions provided on both sides in the front-rear direction on the inner peripheral surface of a tubular portion 54 in the upper housing 40 to be described later, whereby the tubular housing 38 is assembled with the upper housing 40.

The upper housing 40 includes a lid plate portion 50 extending in a perpendicular direction (direction orthogonal to the vertical direction), and the lid plate portion 50 is formed in such a size as to be able to cover the upper opening 42 of the lower housing 44. The lid plate portion 50 is formed with a through hole 52 penetrating in a thickness direction (vertical direction), and the tubular portion 54 having a substantially tubular shape and projecting upward is formed on an outer peripheral edge part of this through hole 52. In short, an inner hole of the tubular portion 54 extending in the vertical direction and the through hole 52 provided in the lid plate portion 50 communicate with each other to form a communication hole 56 penetrating through the tubular portion 54 and the lid plate portion 50 in the vertical direction. Further, engaging frame bodies 58 projecting downward are provided on both sides in the lateral direction in the lid plate portion 50.

As also shown in FIGS. 3, 4 and 6, a substantially tubular inner insertion tube portion 60 to be inserted into the lower housing 44 when the upper housing 40 is assembled with the lower housing 44 is provided on the lower surface of the lid plate portion 50 in the upper housing 40. That is, the inner insertion tube portion 60 projecting downward is provided on an outer peripheral part of the lid plate portion 50, and an inner hole of the inner insertion tube portion 60 also communicates with the communication hole 56 in the upper housing 40.

Note that the tubular portion 54 of the upper housing 40 is inserted into the inside of the peripheral wall 36 in the tubular housing 38 and the upper housing 40 and the tubular housing 38 are assembled. On the outer peripheral surface of the tubular portion 54, an annular waterproof rubber 62 is externally mounted between the upper housing 40 and the tubular housing 38 in the vertical direction. In this way, water intrusion through an assembled part of the upper housing 40 and the tubular housing 38 is prevented. Further, an O-ring 64 is mounted on the outer peripheral surface of the inner insertion tube portion 60 to be inserted into the lower housing 44. This O-ring 64 is compressed between the inner insertion tube portion 60 and the lower housing 44, whereby water intrusion through an assembled part of the upper housing 40 and the lower housing 44 is prevented.

The lower housing 44 has a substantially rectangular box shape open upward as a whole and includes a bottom wall portion 66 and a peripheral wall portion 68 projecting upward from an outer peripheral edge part of the bottom wall portion 66. That is, the peripheral wall portion 68 includes a front wall 70, a rear wall 72 and side walls 74, 74 on both left and right sides, any of these walls extending in the vertical direction. The front wall 70 is formed with the substantially circular wire pull-out openings 14 penetrating in a thickness direction (front-rear direction). Since the pair of wires 12, 12 are provided in this embodiment, a pair of the wire pull-out openings 14, 14 are formed side by side in the lateral direction in the front wall 70. Further, the front wall 70 is provided with an accommodating tube portion 76 projecting forward, and the pair of wire pull-out openings 14, 14 are covered from outside by this accommodating tube portion 76. The accommodating tube portion 76 has an outer shape long in the lateral direction and has a substantially rectangular shape with rounded corners or a substantially oval shape.

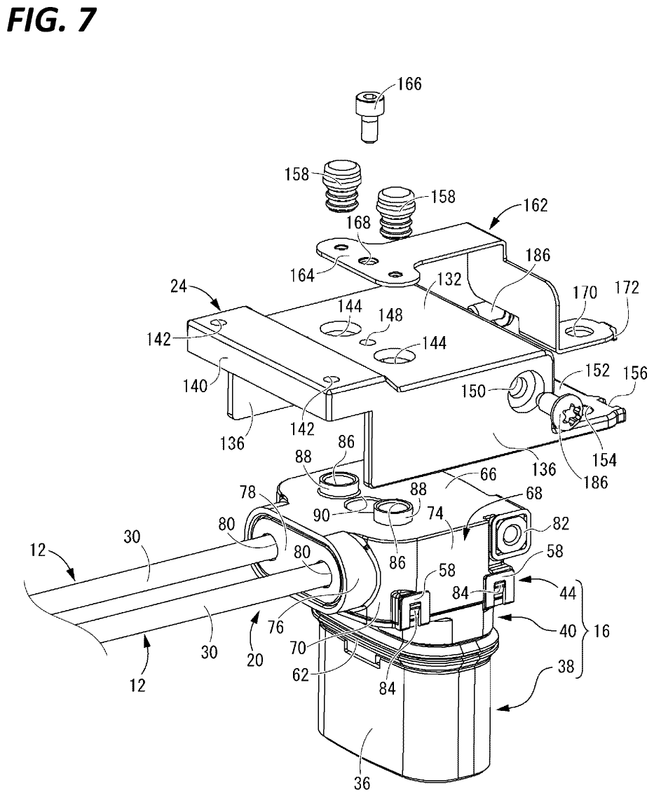

As also shown in FIG. 7, a waterproof rubber 78 serving as a waterproof member made of a resilient material such as rubber is accommodated into this accommodating tube portion 76. The waterproof rubber 78 is shaped to substantially correspond to the accommodating tube portion 76, and formed with insertion holes 80, 80 penetrating in the thickness direction at positions corresponding to the wire pull-out openings 14, 14 in the front wall 70. The waterproof rubber 78 is formed to be slightly larger than the accommodating tube portion 76, and assembled substantially in a compressed state with the accommodating tube portion 76 when the connector 10 is assembled. In this way, water intrusion into the connector housing 16 through the respective wire pull-out openings 14 is prevented. Note that the connector housing 16 (tubular housing 38, upper housing 40 and lower housing 44) is shown in an assembled state and the wire holding portion 22 and the pressing portion 26 are not shown for easy viewing in FIG. 7.

Further, nuts 82 (nut in the rear wall 72 is not shown), to which bolts 186 to be described later are fastened when the connector housing 16 and the shield shell 24 are fixed, are provided substantially in an embedded state in the rear wall 72 and the left side wall 74. Furthermore, engaging claws 84 to be engaged with the respective engaging frame bodies 58 of the upper housing 40 when the upper housing 40 is assembled are provided on an upper end part of the outer surface of each side wall 74.

Here, as shown in FIG. 7, the bottom wall portion 66 is provided with through holes penetrating in the vertical direction, and voltage detection holes 86 are constituted by these through holes. In this embodiment, a pair of voltage detection holes 86, 86 are provided apart from each other in the lateral direction. That is, although not shown, a core wire exposed part having the insulation coating 30 stripped therefrom is provided in an intermediate part in a length direction of each wire 12, and whether or not each wire 12 is in an energized state can be confirmed, for example, by inserting a voltage detection probe or the like through each voltage detection hole 86 and bringing the voltage detection probe or the like into contact with the core wire exposed part. These voltage detection holes 86 can be sealed by plug members 158 to be described later.

Specifically, hollow cylindrical portions 88 projecting downward are provided on the lower surface of the bottom wall portion 66, and the voltage detection hole 86 is configured to include an inner hole of the hollow cylindrical portion 88. That is, in this embodiment, a pair of the hollow cylindrical portions 88, 88 are provided apart from each other in the lateral direction. In short, each voltage detection hole 86 is open in the lower surface of the connector housing 16 (bottom wall portion 66 of the lower housing 44) through the inner hole of each hollow cylindrical portion 88. Further, a circular recess 90 open downward is formed between the respective hollow cylindrical portions 88 projecting downward in the lateral direction in the lower surface of the bottom wall portion 66.

### (Wire Holding Portion 22)

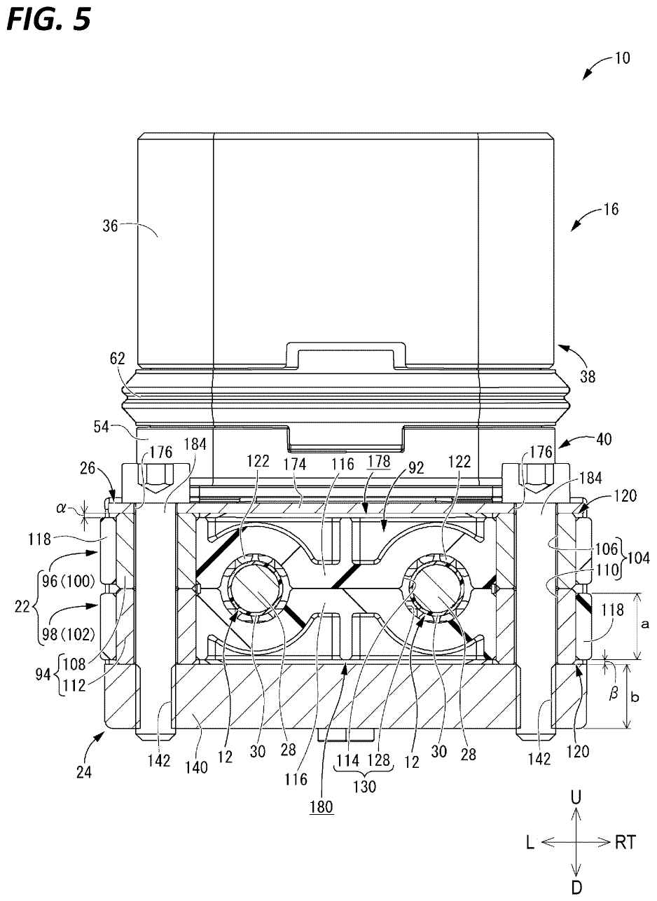

As also shown in FIG. 5, the wire holding portion 22 integrally includes a body portion 92 made of synthetic resin for holding the projecting parts 22 of the respective wires 12 projecting out from the respective wire pull-out openings 14 and bolt insertion tube portions 94 made of metal and extending through the body portion 92 in a first direction, which is a direction intersecting an axial direction of each wire 12 (front-rear direction at a position where the wire holding portion 22 is disposed). In this embodiment, the first direction, which is an extension direction of the bolt insertion tube portions 94, is the vertical direction, which is a direction orthogonal to the axial direction (front-rear direction) of each wire 12.

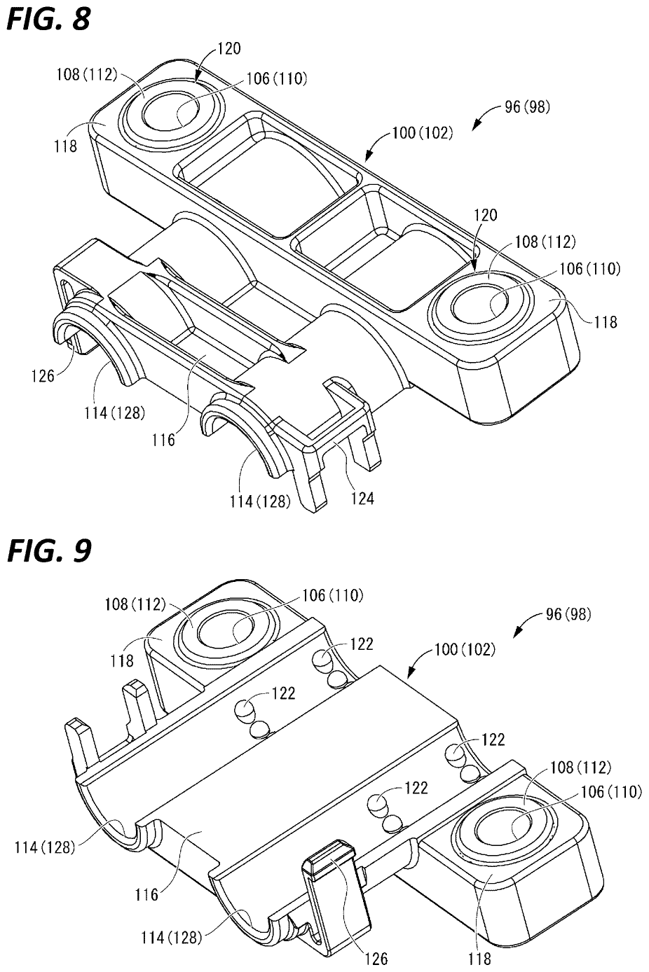

Particularly, the wire holding portion 22 of this embodiment can be disassembled and assembled in the vertical direction and is composed of an upper wire holding portion 96 and a lower wire holding portion 98. Note that, in this embodiment, the upper and lower wire holding portions 96, 98 are constituted by the same members, and one member (e.g. the upper wire holding portion 96) can be the other member (e.g. the lower wire holding portion 98) by being vertically inverted. Therefore, in the following description, the upper wire holding portion 96 is mainly described with reference to FIGS. 8 and 9, and the description of the lower wire holding portion 98 is partially omitted.

That is, the body portion 92 made of synthetic resin for holding the respective wires 12 can also be disassembled and assembled in the vertical direction and is composed of a first holding portion 100 on an upper side and a second holding portion 102 on a lower side. That is, the upper wire holding portion 96 includes the first holding portion 100 and the lower wire holding portion 98 includes the second holding portion 102. Note that the first and second holding portions 100, 102 have the same shape.

Similarly, the bolt insertion tube portion 94 can also be disassembled in the vertical direction. The bolt insertion tube portion 94 has a substantially hollow cylindrical shape as a whole and includes a bolt insertion hole 104 penetrating in the vertical direction. The bolt insertion tube portion 94 is composed of a first bolt insertion tube portion 108, which is an upper hollow cylindrical part and includes a bolt insertion hole 106 on an upper side, and a second bolt insertion tube portion 110, which is a lower hollow cylindrical part and includes a bolt insertion hole 110 on a lower side. Further, the bolt insertion hole 104 penetrating through the bolt insertion tube portion 94 in the vertical direction is composed of the bolt insertion hole 106 on the upper side and the bolt insertion hole 110 on the lower side. That is, the upper wire holding portion 96 includes the first bolt insertion tube portion 108, and the lower wire holding portion 98 includes the second bolt insertion tube portion 112. Note that the first and second bolt insertion tube portions 108, 112 have the same shape.

By assembling these upper and lower wire holding portions 96, 98 to sandwich the respective wires 12 from both sides in the first direction (vertical direction), the respective wires 12 are held by the wire holding portion 22. In short, the wire holding portion 22 is configured and the respective wires 12 are held by assembling one member and the vertically inverted other member. These upper and lower wire holding portions 96, 98 extend in the axial direction (front-rear direction) of each wire 12 as a whole.

Further, in the first holding portion 100 of the upper wire holding portion 96, first recesses 114 to be held in contact with the outer peripheral surfaces of the respective wires 12 by accommodating the respective wires 12 are open in a contact surface with the second holding portion 102 in the lower wire holding portion 98, i.e. an overlapping surface of the first holding portion 100 with the second holding portion 102. The first recess 114 extends over an entire length in the front-rear direction in the first holding portion 100. Since the pair of wires 12, 12 are provided in this embodiment, a pair of the first recesses 114, 114 are provided apart from each other in the lateral direction in the first holding portion 100.

The first holding portion 100 includes a coupling portion 116 coupling the respective first recesses 114 between the pair of first recesses 114, 114 in the lateral direction and projecting portions 118 projecting toward both sides in the lateral direction in rear parts of the respective first recesses 114. The coupling portion 116 is provided substantially over the entire length in a length direction (front-rear direction) of the first holding portion 100 (respective first recesses 114). Further, each projecting portion 118 has a substantially rectangular outer shape in a plan view. The first bolt insertion tube portion 108 is arranged substantially in an embedded state in each of these projecting portions 118. In this embodiment, the first holding portion 100 and the first bolt insertion tube portions 108 are integrally formed, and the upper wire holding portion 96 is formed as an integrally molded product of the first holding portion 100 provided with the first bolt insertion tube portions 108.

A dimension in the length direction (dimension in the vertical direction) of each of these first bolt insertion tube portions 108 is slightly larger than a dimension in the vertical direction of each projecting portion 118 (substantially equal to a dimension in the vertical direction of the first holding portion 100). In this way, projecting end parts 120 projecting further toward both sides in the vertical direction than the respective projecting portions 118 (first holding portion 100) are constituted by end parts on both sides in the length direction (both end parts in the vertical direction) of the respective first bolt insertion tube portions 108.

A projecting dimension α (see FIG. 5) of a part projecting upward from the first holding portion 100 (each projecting portion 118) in each of these projecting end parts 120 is not limited, but is preferably, for example, 0.5 mm or more, more preferably 0.6 mm or more. By setting the projecting dimension α of each projecting end part 120 to 0.5 mm or more, a gap 178, 180 to be described later can be stably formed and the expansion of the resin (body portion 92) under a high temperature environment can be allowed. Note that, although an upper limit value of the projecting dimension α of each projecting end part 120 is not limited, this upper limit value is, for example, set to 1.0 mm or less. In this way, it is avoided that the gaps 178, 180 become unnecessarily large and, consequently, the enlargement of the connector 10 can also be avoided.

Note that wire pressing ribs 122 are provided on the inner peripheral surface of each first recess 114 to be overlapped on each wire 12. In this embodiment, a plurality of the wire pressing ribs 122 are provided at a plurality of positions on the inner peripheral surface of a rear part of each first recess 114 while being spaced apart in a circumferential direction. As also shown in FIG. 5, a projecting tip part of each wire pressing rib 122 has a substantially hemispherical shape. In this embodiment, each wire pressing rib 122 in each first recess 114 extends straight downward, and a center axis direction of the projecting tip part having the substantially hemispherical shape is the vertical direction. Particularly, in this embodiment, the plurality of wire pressing ribs 122 provided at the plurality of positions in the circumferential direction are distributed at two positions spaced apart from each other in the axial direction of each wire 12 (length direction of each first recess 114 and front-rear direction). Specifically, the plurality of wire pressing ribs 122 spaced apart in the circumferential direction are provided at positions substantially corresponding to front and rear end parts of each projecting portion 118 in the front-rear direction.

Further, a resilient lock piece 124 projecting toward the contact surface (overlapping surface) with the second holding portion 102 and a lock claw portion 126 engageable with the resilient lock piece 124 are provided on both sides in the lateral direction of front parts of the respective first recesses 114 in the first holding portion 100. In other words, the respective first recesses 114 in the first holding portion 100 extend beyond the respective first bolt insertion tube portions 108 in a projecting direction (direction from rear to front) of the respective wires 12 from the respective wire pull-out openings 14, and the resilient lock piece 124 and the lock claw portion 126 are provided on extending end sides (front end sides) of the respective first recesses 114 in the first holding portion 100.

As described above, the upper and lower wire holding portions 96, 98 have the same shape and are arranged in a state vertically inverted relative to each other. That is, in the second holding portion 102 of the lower wire holding portion 98, second recesses 128 to be held in contact with the outer peripheral surfaces of the respective wires 12 by accommodating the respective wires 12 are open in a contact surface with the first holding portion 100 in the upper wire holding portion 96. The second holding portion 102 is provided with a pair of the second recesses 128, 128 spaced apart from each other in the lateral direction.

In the second holding portion 102, the pair of second recesses 128, 128 are coupled by a coupling portion 116 and projecting portions 118 projecting toward both sides in the lateral direction in rear parts of the respective second recesses 128. The second bolt insertion tube portion 112 is arranged substantially in an embedded state in each of these projecting portions 118. In this embodiment, the lower wire holding portion 98 is formed as an integrally molded product of the second holding portion 102 provided with the second bolt insertion tube portions 112. Further, projecting end parts 120 projecting further toward both sides in the vertical direction than the respective projecting portions 118 (second holding portion 102) are constituted by end parts on both sides in the length direction (both end parts in the vertical direction) of the respective second bolt insertion tube portions 112. A projecting dimension β (see FIG. 5) of the projecting end part 120 from the second holding portion 102 in each second bolt insertion tube portion 112 is set to the same value as the projecting dimension α of the projecting end part 120 from the first holding portion 100 in each first bolt insertion tube portion 108.

Further, a plurality of wire pressing ribs 122 are provided on the inner peripheral surface of each second recess 128 to be overlapped on each wire 12. The shape, the arrangement mode and the like of the respective wire pressing ribs 122 provided in each second recess 128 are similar to those of the respective wire pressing ribs 122 provided in each first recess 114. Further, a resilient lock piece 124 and a lock claw portion 126 engageable with each other are provided on both sides in the lateral direction of front parts of the respective second recesses 128 in the second holding portion 102.

As described later, when the upper and lower wire holding portions 96, 98 are assembled, the respective first recesses 114 and the respective second recesses 128 are overlapped and connected to configure wire through holes 130 extending in the front-rear direction. The respective wire pressing ribs 122 are substantially annularly arranged on the inner peripheral surface of this wire through hole 130 by the respective wire pressing ribs 122 in each first recess 114 and the respective wire pressing ribs 122 in each second recess 128. By providing such wire pressing ribs 122, the respective wire pressing ribs 122 bite into the insulation coatings 30 of the respective wires 12 when the connector 10 is assembled, whereby forces for holding the respective wires 12 by the wire holding portion 22 can be improved.

### (Shield Shell 24)

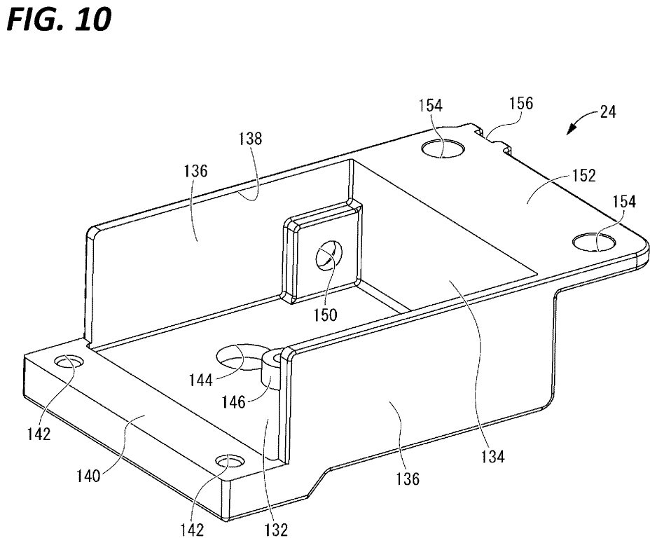

As also shown in FIG. 1 and the like, a lower part of the connector housing 16 structured as described above is accommodated into the shield shell 24 made of metal. As also shown in FIG. 10, the shield shell 24 has a substantially box shape open upward as a whole and is provided with a bottom wall 132 substantially rectangular in a plan view and a rear wall portion 134 and a pair of side wall portions 136, 136 projecting upward from a rear side and both left and right sides of an outer peripheral edge part of the bottom wall 132. An accommodation recess 138 for accommodating the connector housing 16 is constituted by a region surrounded by the bottom wall 132, the rear wall portion 134 and the pair of side wall portions 136, 136.

Note that, in this embodiment, a front part of the bottom wall 132 extends further forward than the respective side wall portions 136, and a front extending portion 140 is constituted by this extending part. The front extending portion 140 is formed with bolt holes 142, into which bolts 184 to be described later can be tightened. Thus, by placing the front extending portion 140 on the wire holding portion 22, overlapping the pressing portion 26 on the wire holding portion 22 from above and tightening the bolts 184, the wire holding portion 22 can be sandwiched in the vertical direction between the front extending portion 140 and the pressing portion 26, which are both made of metal.

Further, in the shield shell 24, the bottom wall 132 to be overlapped on a bottom wall portion 66 of the connector housing 16 is formed with insertion holes 144, through which the respective hollow cylindrical portions 88 projecting downward from the bottom wall portion 66 are inserted and which penetrate through the bottom wall 132 in the thickness direction (vertical direction). These insertion holes 144 are formed at positions corresponding to the respective hollow cylindrical portions 88, and a pair of the insertion holes 144, 144 are provided apart from each other in the lateral direction. A hollow cylindrical circular protrusion 146 projecting upward from the bottom wall 132 is provided between the respective insertion holes 144 in the lateral direction, and a bolt hole 148, into which a bolt 166 to be described later can be tightened, is constituted by an inner hole of this circular protrusion 146.

Further, bolt insertion holes 150 (bolt insertion hole in the rear wall portion 134 is not shown), through which bolts 186 to be described later are inserted, are provided at positions corresponding to the nuts 82 provided in the rear wall 72 and the left side wall 74 of the connector housing 16 in the rear wall portion 134 and the left side wall portion 136 in the shield shell 24. An upper end part of the rear wall portion 134 is provided with an external connection portion 152 projecting rearward, and the external connection portion 152 is formed with bolt insertion holes 154 penetrating in the thickness direction (vertical direction). By placing terminal portions provided on unillustrated external wires or the like and inserting and tightening unillustrated bolts into the respective bolt insertion holes 154, the shield shell 24 and the external wires or the like are electrically connected. Further, a positioning portion 156 engageable with a claw portion 172 of a voltage detection hole sealing member 160 to be described later is formed on a left end part of the rear end surface of the external connection portion 152. The positioning portion 156 is configured to have a relatively concave shape by both sides in the lateral direction of an engaged position of the claw portion 172 projecting rearward.

In this embodiment, the voltage detection hole sealing member 160 provided with the plug members 158 for sealing the respective voltage detection holes 86 of the connector housing 16 is assembled with the lower surface of the shield shell 24. Two plug members 158 are provided to correspond to the respective voltage detection holes 86, and a pair of the plug members 158, 158 are arranged apart from each other in the lateral direction. Each plug member 158 has a substantially cylindrical shape as a whole and is, for example, made of a resilient material such as rubber. A maximum outer diameter of a part of each plug member 158 to be inserted into the voltage detection hole 86 is larger than an inner diameter of each hollow cylindrical portion 88 constituting the voltage detection hole 86, and each plug member 158 is fixed to the voltage detection hole 86 by being substantially press-fit and inserted into the voltage detection hole 86 from below.

These plug members 158 are assembled with a plug member holder 162 for holding the respective plug members 158. The plug member holder 162 extends in the front-rear direction as a whole while being bent along the bottom wall 132, the rear wall portion 134 and the external connection portion 152 of the shield shell 24 and is, for example, made of metal. That is, in one end part (front end part) of the plug member holder 162, a holding portion 164 for holding the respective plug members 158 is provided and a bolt insertion hole 168, through which the bolt 166 is inserted, is formed in a lateral central part of the holding portion 164. Further, in the other end part (rear end part) of the plug member holder 162, a bolt insertion hole 170 is formed and the bolt insertion hole 170 and the bolt insertion hole 154 in the external connection portion 152 communicate with each other when the plug member holder 162 is fixed to the shield shell 24. Further, the claw portion 172 is formed on the other end part (rear end part) of the plug member holder 162, and the claw portion 172 is engaged with the positioning portion 156 provided on the rear end part of the external connection portion 152 when the plug member holder 162 is fixed to the shield shell 24.

In this embodiment, these plug members 158 and plug member holder 162 are integrally formed to configure the voltage detection hole sealing member 160. This voltage detection hole sealing member 160 is overlapped on and fixed to the connector housing 16 via the shield shell 24 from below, and the respective voltage detection holes 86 are sealed by the respective plug members 158. That is, the respective plug members 158 are press-fit into the respective voltage detection holes 86 (respective hollow cylindrical portions 88) open downward via the insertion holes 144 of the shield shell 24, the claw portion 172 is engaged with the positioning portion 156 on the external connection portion 152, the bolt 166 is inserted through the bolt insertion hole 168 and tightened into the bolt hole 148 in the shield shell 24, whereby the voltage detection hole sealing member 160 can be fixed to the shield shell 24. In short, the respective voltage detection holes 86 are open downward through the respective insertion holes 144 in the shield shell 24 by unfastening the bolt 166 from the shield shell 24, gripping the voltage detection hole sealing member 160 (plug member holder 162) and pulling out the respective plug members 158 from the respective voltage detection holes 86 (respective hollow cylindrical portions 88).

### (Pressing Portion 26)

The pressing portion 26 is a member to be bolt-fastened to the shield shell 24 while sandwiching the wire holding portion 22 between the shield shell 24 and the pressing portion 26 in the first direction (vertical direction), which is a direction intersecting the axial direction of the wires 12 (front-rear direction). In this embodiment, the pressing portion 26 is bolt-fastened to the shield shell 24 while being overlapped from above on the wire holding portion 22 placed on the front extending portion 140 of the shield shell 24.

As also shown in FIGS. 1 and 3, the pressing portion 26 includes a pressing wall portion 174 for covering and pressing the wire holding portion 22 from above. The pressing wall portion 174 has a substantially rectangular shape in a plan view, and bolt insertion holes 176, 176 penetrating in the vertical direction are formed on both sides in the lateral direction of the pressing wall portion 174. That is, when the pressing portion 26 is fixed to the shield shell 24, the wire holding portion 22 is sandwiched in the vertical direction between the pressing wall portion 174 and the front extending portion 140.

Here, as described above, in the wire holding portion 22, the projecting end parts 120, which are end parts of the first bolt insertion tube portions 108, project upward from the first holding portion 100 in the upper wire holding portion 96 and the projecting end parts 120, which are end parts of the second bolt insertion tube portions 112, project downward from the second holding portion 100 in the lower wire holding portion 98. Accordingly, when the pressing portion 26 is fixed to the shield shell 24, the pressing wall portion 174 and the projecting end parts 120 of the first bolt insertion tube portions 108 are in contact and the gap 178 is formed between the first holding portion 100 and the pressing wall portion 174 as shown in FIGS. 3 and 5. Further, the front extending portion 140 and the projecting end parts 120 of the second bolt insertion tube portions 112 are in contact and the gap 180 is formed between the second holding portion 102 and the front extending portion 140. That is, the respective projecting end parts 120 of the first and second bolt insertion tube portions 108, 112 project from the first and second holding portions 100, 102 and are in contact with the pressing wall portion 174 and the front extending portion 140 on both sides in the vertical direction, whereby the first and second holding portions 100, 102 are spaced apart from the pressing wall portion 174 and the front extending portion 140 across the gaps 178, 180. Note that, although it is not clear since lightening holes in the first and second holding portions 100, 102 are shown in FIGS. 3 and 5, the upper end surface of the first holding portion 100 and the lower end surface of the second holding portion 102 are located on the same planes as the end surfaces of the projecting portions 118 provided in the first and second holding portions 100, 102.

Dimensions in the vertical direction of these gaps 178, 180 may be determined by the following (Equation 1) besides being set by the aforementioned projecting dimension α of the first bolt insertion tube portions 108 from the first holding portion 100 and the aforementioned projecting dimension β of the second bolt insertion tube portions 112 from the second holding portion 102.

$$Gap > ( a \times ( t 1 - t 2 ) \times c ) + ( b \times ( t 1 - t 2 ) \times d ) \qquad ( Equation 1 )$$

Here, in the above (Equation 1), a (see FIG. 5) denotes a plate thickness of the first or second holding portion 100, 102 in the first direction (vertical direction), b (see FIG. 5) denotes a plate thickness of the pressing portion 26 or the shield shell 24 in a part in contact with the first or second holding portion 100, 102 in the first direction (vertical direction) and is a plate thickness of the pressing wall portion 174 or the front extending portion 140 in this embodiment, c denotes a linear expansion coefficient of a material of the body portion 92 (first and second holding portions 100, 102), d denotes a linear expansion coefficient of a material of the pressing portion 26 or the shield shell 24, t1 denotes a heat resistant temperature of the insulation coating 30 in each wire 12, and t2 denotes a normal temperature (e.g. in a range of 5° C. to 35° C.).

A tubular portion 182 projecting forward is provided on a front end part of the pressing wall portion 174, and an inner hole of the tubular portion 182 is open on both sides in the front-rear direction. When the connector 10 is assembled, a front part of the wire holding portion 22 (first and second holding portions 100, 102) is covered by the tubular portion 182.

### (Assembly Method of Connector 10)

A specific example of an assembly method of the connector 10 is described below. Note that the assembly method of the connector 10 is not limited to the one described below.

First, the insulation coating 30 is stripped in the end part of each wire 12 to expose the core wire 28, and the terminal 18 is fixed. Thereafter, the end part of each wire 12 on the side fixed to the terminal 18 is inserted into the communication hole 56 of the upper housing 40, each wire 12 is curved while the end part of each wire 12 on the side opposite to the side fixed to the terminal 18 is inserted into each wire pull-out opening 14 in the lower housing 44, and the upper and lower housings 40, 44 are caused to face in the vertical direction. Then, the upper and lower housings 40, 44 are brought closer to each other in the vertical direction and fixed to each other by engaging the respective engaging frame bodies 58 in the upper housing 40 and the respective engaging claws 84 in the lower housing 44.

Further, the end part of each wire 12 on the side opposite to the side fixed to the terminal 18 is inserted into the insertion hole 80 in the waterproof rubber 78 and the waterproof rubber 78 is accommodated into the accommodating tube portion 76 in the lower housing 44. Further, the waterproof rubber 62 and the tubular housing 38 are assembled with the upper housing 40 from above. In this way, the connector housing 16 assembled with the respective wires 12 is completed.

Subsequently, the upper and lower wire holding portions 96, 98 are caused to face the projecting parts 20 of the respective wires 12 projecting out from the respective wire pull-out openings 14 from the both sides in the vertical direction, and brought closer to each other. Then, the upper and lower wire holding portions 96, 98 are assembled with each other by engaging the respective resilient lock pieces 124 and the respective lock claw portions 126 in these upper and lower wire holding portions 96, 98. In this way, the bolt insertion holes 106 in the respective first bolt insertion tube portions 108 and the bolt insertion holes 110 in the respective second bolt insertion tube portions 112 communicate in the vertical direction to configure the respective bolt insertion holes 104 in the wire holding portion 22. Thereafter, the front part of the wire holding portion 22 is inserted into the tubular portion 182 of the pressing portion 26, and the respective bolt insertion holes 104 in the wire holding portion 22 and the respective bolt insertion holes 176 in the pressing portion 26 are caused to communicate in the vertical direction.

The lower part of the connector housing 16 is accommodated into the accommodation recess 138 in the shield shell 24, and the wire holding portion 22 is placed on the front extending portion 140 of the shield shell 24. Thereafter, the pressing portion 26 and the wire holding portion 22 are fixed to the shield shell 24 by the bolts 184. That is, by placing the wire holding portion 22 on the front extending portion 140, the pressing portion 26 (pressing wall portion 174), the respective first bolt insertion tube portions 108, the respective second bolt insertion tube portions 112 and the shield shell 24 (front extending portion 140) are successively overlapped in the vertical direction and fastened by the respective bolts 184 through the respective bolt insertion holes 176, 106 and 110 and the respective bolt holes 142 communicating each other.

Further, the shield shell 24 and the connector housing 16 are fixed by the bolts 186 by inserting and fastening the bolts 186 to the respective nuts 82 provided in the connector housing 16 from behind and left of the shield shell 24. Note that, when the bottom wall 132 of the shield shell 24 and the bottom wall portion 66 of the connector housing 16 are overlapped and the connector housing 16 is accommodated into the accommodation recess 138, the respective hollow cylindrical portions 88 are inserted into the respective insertion holes 144 and the circular protrusion 146 is inserted into the circular recess 90. Therefore, a positioning effect of the shield shell 24 and the connector housing 16 can be exhibited by the respective insertion holes 144 and the respective hollow cylindrical portions 88, and the circular protrusion 146 and the circular recess 90.

Thereafter, the respective voltage detection holes 86 are sealed by the respective plug members 158 by overlapping the voltage detection hole sealing member 160 on the shield shell 24 from below and tightening the bolt 166. In this way, the connector 10 is completed.

In such an assembled state of the connector 10, the wire holding portion 22 is located in front of the waterproof rubber 78 provided in the connector housing 16 as also shown in FIG. 3. As a result, the separation of the waterproof rubber 78 to outside is hindered by the wire holding portion 22 and the wire holding portion 22 has a retainer function of hindering the separation of the waterproof rubber 78 to outside.

According to the connector 10 of this embodiment, the wire holding portion 22 for holding the projecting parts 20 of the respective wires 12 from the connector housing 16 is sandwiched by the pressing portion 26 (pressing wall portion 174) and the shield shell 24 (front extending portion 140), both being made of metal. Particularly, the wire holding portion 22 includes the respective bolt insertion tube portions 94 made of metal and integrally provided in the body portion 92 made of synthetic resin, and the projecting end parts 120 of the bolt insertion tube portions 94 project toward the both sides in the vertical direction from the body portion 92 and are in direct contact with the pressing portion 26 (pressing wall portion 174) and the shield shell 24 (front extending portion 140). By bolt-fixing the wire holding portion 22 in such a state, axial forces of the respective bolts 184 can be stably applied to between the pressing portion 26 and the shield shell 24. Therefore, the wire holding portion 22 can be firmly held between the shield shell 24 and the pressing portion 26, and the rattling of the upper and lower wire holding portions 96, 98 due to vibration is suppressed. As a result, a holding force for holding each wire 12 by the wire holding portion 22 is improved and the transfer of an external force due to vibration or the like to each terminal 18 provided on the end part of the wire 12 is prevented.

Further, the projecting portions 120 of the bolt insertion tube portions 94 project outward in the vertical direction from the body portion 92 constituting the wire holding portion 22, and the gaps 178, 180 are provided in the vertical direction between the body portion 92 (first and second holding portions 100, 102) and the pressing portion 26 (pressing wall portion 174) and between the body portion 92 (first and second holding portions 100, 102) and the shield shell 24 (front extending portion 140). By providing these gaps 178, 180, the expansive deformation of the first and second holding portions 100, 102 made of synthetic resin is allowed under a high temperature environment, the biting into each insulation coating 30 under the high temperature environment is suppressed as compared to the case where no gaps are provided, and a risk of the creep rupture of the insulation coating 30 can be advantageously reduced. As a result, also when the expansive deformation of the first and second holding portions 100, 102 is released, for example, under the high temperature environment, each insulation coating 30 can stably return to an initial shape and the formation of gaps between each insulation coating 30 and the first and second holding portions 100, 102 is suppressed. In this way, even in the case of exposure to the high temperature environment, a reduction in holding performance by the wire holding portion 22 can be avoided and a satisfactory state of holding the respective wires 12 by the wire holding portion 22 can be maintained.

Particularly, since the bolt insertion tube portions 94 project toward the both sides in the first direction (vertical direction) of the body portion 92, the gaps 178, 180 can be formed on the both sides in the vertical direction of the body portion 92 (first and second holding portions 100, 102), and the expansive deformation of the first and second holding portions 100, 102 is more stably allowed under the high temperature environment. As a result, the formation of gaps between the respective insulation coatings 30 and the first and second holding portions 100, 102 is more reliably avoided, for example, under a normal temperature environment, and a reduction in holding performance is further suppressed.

In the bolt insertion tube portion 94, the projecting dimensions a, p from the body portion 92 are preferably 0.5 mm or more. In this way, the gaps 178, 180 can be stably formed between the body portion 92 (first and second holding portions 100, 102) and the pressing portion 26 and between the body portion 92 (first and second holding portions 100, 102) and the shield shell 24.

The dimensions in the vertical direction of the gap 178 between the first holding portion 100 and the pressing portion 26 and the gap 180 between the second holding portion 102 and the shield shell 24 may be determined by (Equation 1) described above. The gaps 178, 180 can be stably formed also by this.

The wire holding portion 22 is composed of the upper wire holding portion 96 on the upper side and the lower wire holding portion 98 on the lower side. That is, the body portion 92 is composed of the first and second holding portions 100, 102 and the bolt insertion tube portion 94 is composed of the first bolt insertion tube portion 108 and the second bolt insertion tube portion 112. By configuring the wire holding portion 22 to have upper and lower divided structures in this way, the upper and lower wire holding portions 96, 98 can be assembled from the both sides in the vertical direction of the respective wires 12 and the workability of an assembly operation can be improved. Particularly, by using the same members as the upper and lower wire holding portions 96, 98, manufacturing cost, labor for component management and the like can be reduced.

Further, both the first and second holding portions 100, 102 include the resilient lock piece 124 and the lock claw portion 126 engageable with each other. In this way, the first holding portion 100 (upper wire holding portion 96) and the second holding portion 102 (lower wire holding portion 98) can be assembled with each other while having the same shape. Further, by a locking mechanism composed of the respective resilient lock pieces 124 and the respective lock claw portions 126, the wire holding portion 22 can be temporarily fixed to the respective wires 12 before being bolt-fixed to the shield shell 24. In this way, a fastening operation by the respective bolts 184 can be stably performed.

Particularly, these resilient lock pieces 124 and lock claw portions 126 are provided in the front parts of the first and second holding portions 100, 102 and the first and second bolt insertion tube portions 108, 112, into which the respective bolts 184 are inserted, are provided in the rear parts of the first and second holding portions 100, 102. That is, the front parts of the first and second holding portions 100, 102 can be fixed by the locking mechanism, the rear parts of the first and second holding portions 100, 102 can be fixed by bolt fastening, and the formation of gaps between the first and second holding portions 100, 102 and the respective wires 12 can be more reliably prevented on the both front and rear sides.

The respective wire pressing ribs 122 are provided at the plurality of positions spaced apart in the circumferential direction on the inner peripheral surfaces of each first recess 114 and each second recess 128. These wire pressing ribs 122 bite into the insulation coating 30 of each wire 12, whereby a displacement of each wire 12 in the wire holding portion 22 is more reliably prevented. Particularly, in this embodiment, the respective wire pressing ribs 122 are provided near the first and second bolt insertion tube portions 108, 112, into which the respective bolts 184 are inserted, in the first and second holding portions 100, 102. In this way, tightening forces of the respective bolts 184 can be applied to the respective wire pressing ribs 122 and performance for holding the respective wires 12 by the respective wire pressing ribs 122 can be improved.

Further, the plurality of wire pressing ribs 122 spaced apart in the circumferential direction on the inner peripheral surfaces of each first recess 114 and each second recess 128 are provided at two positions spaced apart from each other in the front-rear direction, which is the axial direction of each wire 12. In this way, a displacement in the front-rear direction, a pivotal displacement (twist) in the vertical direction and the like of each wire 12 with respect to the wire holding portion 22 can be more effectively prevented.

The wire holding portion 22 is fixed in front of the waterproof rubber 78 provided in the connector housing 16, and the separation of the waterproof rubber 78 to outside is hindered by the wire holding portion 22. In this way, the wire holding portion 22 has not only a wire holding function, but also a retainer function of hindering the separation of the waterproof rubber 78, it is, for example, not necessary to separately provide a member for holding the respective wires and a member for hindering the separation of the waterproof rubber, and a reduction in the number of components and structure simplification in the connector 10 are also achieved.

### <Modifications>

Although the embodiment has been described in detail as the specific example of the present disclosure above, the present disclosure is not limited by this specific description. Modifications, improvements and the like within a range in which the aim of the present disclosure can be achieved are also included in the present disclosure. For example, the following modifications of the embodiment are also included in the technical scope of the present disclosure.

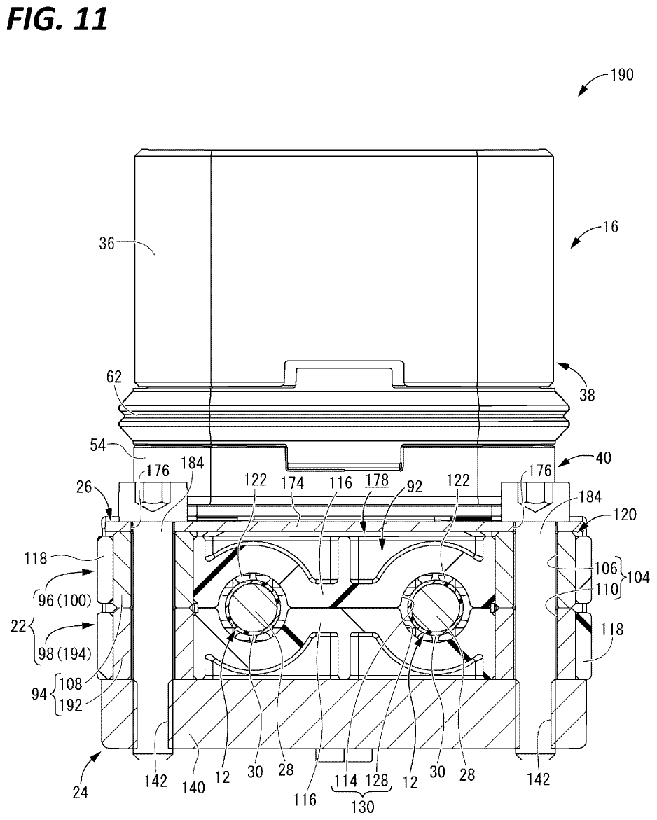

(1) In the above embodiment, the upper and lower wire holding portions 96, 98 have the same structure and the projecting dimension α of the first bolt insertion tube portions 108 from the first holding portion 100 is equal to the projecting dimension β of the second bolt insertion tube portions 112 from the second holding portion 102, but there is no limitation to this mode. For example, the upper and lower wire holding portions may have different structures, i.e. the projecting dimension α of the first bolt insertion tube portions from the first holding portion may be different from the projecting dimension β of the second bolt insertion tube portions from the second holding portion. Specifically, for example, as in a connector 190 shown in FIG. 11, a projecting dimension of second bolt insertion tube portions 192 from a second holding portion 194 may be set to 0 and no gap may be provided between the second holding portion 194 and a shield shell 24 (front extending portion 140). Therefore, in a connector according to the present disclosure, bolt insertion tube portions may project from a body portion only on one side in the first direction (vertical direction) and the body portion may be spaced apart from one of a shield shell and a pressing portion across a gap.

(2) Although the two wires 12, 12 are provided in the above embodiment, one, three or more wires may be provided.

(3) The wire holding portion may be structured such that end parts on one side of the upper and lower wire holding portions are coupled by a hinge portion, besides being composed of the separate upper and lower wire holding portions as in the above embodiment. In this case, the upper and lower wire holding portions can be opened and closed about the hinge portion as a center, and the wires can be held by the wire holding portion by fixing the other end parts of the upper and lower wire holding portions to each other after the upper and lower wire holding portions are opened and the wires are sandwiched therebetween. Further, the body portion of the wire holding portion may be configured as a single resin component in which wire through holes penetrate and single bolt insertion tube portions are embedded. In such a case, the wires may be inserted through the wire through holes and the wire holding portion may be mounted on the projecting parts of the wires in advance, for example, before the terminals are connected to the wires.

(4) Although the respective wire pressing ribs 122 are provided on both the inner peripheral surfaces of the respective first recesses 114 in the first holding portion 100 and the inner peripheral surfaces of the respective second recesses 128 in the second holding portion 102 in the embodiment, wire pressing ribs may be provided on the inner peripheral surfaces of either the first or second recesses 114, 128 or no wire pressing ribs may be provided. Even if the wire pressing ribs are provided, the wire pressing ribs are not limited to those formed into a semi-annular shape on the inner peripheral surface(s) of each first recess and/or each second recess as in the above embodiment, but an arbitrary shape can be adopted such as a projection shape, a shape extending in the axial direction of each wire and a helical shape. Further, although the respective wire pressing ribs 122 provided in the first and second recesses 114, 128 project in the vertical direction in the above embodiment, the respective wire pressing ribs may project radially of the first and second recesses (wire through holes). Furthermore, the respective wire pressing ribs in each first recess and those in each second recess need not be provided at the same positions in the front-rear direction and may be provided at positions different in the front-rear direction.

(5) Although the connector housing 16 and the shield shell 24 are fixed by tightening the bolts 186 in the above embodiment, engaging protrusions and engaging frame bodies engageable with each other may be, for example, provided and a connector housing and a shield shell may be fixed by the engagement of these.

(6) The shape of the connector housing 16 described in the above embodiment is merely an example, and the shape of a connector housing is not limited. For example, voltage detection holes are not essential in a connector according to the present disclosure, and the voltage detection holes and a voltage detection hole sealing member may not be provided.

### LIST OF REFERENCE NUMERALS

10 connector (embodiment)
12 wire
14 wire pull-out opening
16 connector housing
18 terminal
20 projecting part
22 wire holding portion
24 shield shell
26 pressing portion
28 core wire
30 insulation coating
32 contact point portion
34 wire connecting portion
36 peripheral wall
38 tubular housing
40 upper housing
42 upper opening
44 lower housing
46 holding tube portion
48 terminal assembly opening
50 lid plate portion
52 through hole
54 tubular portion
56 communication hole
58 engaging frame body
60 inner insertion tube portion
62 waterproof rubber
64 O-ring
66 bottom wall portion
68 peripheral wall portion
70 front wall
72 rear wall
74 side wall
76 accommodating tube portion
78 waterproof rubber (waterproof member)
80 insertion hole
82 nut
84 engaging claw
86 voltage detection hole
88 hollow cylindrical portion
90 circular recess
92 body portion
94 bolt insertion tube portion
96 upper wire holding portion
98 lower wire holding portion
100 first holding portion
102 second holding portion
104, 106 bolt insertion hole
108 first bolt insertion tube portion
110 bolt insertion hole
112 second bolt insertion tube portion
114 first recess
116 coupling portion
118 projecting portion
120 projecting end part
122 wire pressing rib
124 resilient lock piece
126 lock claw portion
128 second recess
130 wire through hole
132 bottom wall
134 rear wall portion
136 side wall portion
138 accommodation recess
140 front extending portion
142 bolt hole
144 insertion hole
146 circular protrusion
148 bolt hole
150 bolt insertion hole
152 external connection portion
154 bolt insertion hole
156 positioning portion
158 plug member
160 voltage detection hole sealing member
162 plug member holder
164 holding portion
166 bolt
168, 170 bolt insertion hole
172 claw portion
174 pressing wall portion
176 bolt insertion hole
178, 180 gap
182 tubular portion
184, 186 bolt
190 connector (FIG. 11)
192 second bolt insertion tube portion
194 second holding portion

1. A connector, comprising:
a connector housing including a wire pull-out opening;
a wire to be connected to a terminal accommodated in the connector housing, the wire being pulled out to outside of the connector housing through the wire pull-out opening;
a wire holding portion integrally including a body portion made of synthetic resin for holding a projecting part of the wire projecting out from the wire pull-out opening and a bolt insertion tube portion made of metal extending through the body portion in a first direction intersecting an axial direction of the wire;
a shield shell made of metal for covering the connector housing by being fixed to the connector housing; and
a pressing portion made of metal to be fastened to the shield shell by a bolt inserted into the bolt insertion tube portion while sandwiching the wire holding portion between the shield shell and the pressing portion in the first direction,
the bolt insertion tube portion including a projecting end part projecting from the body portion at least on one side in the first direction, the body portion being spaced apart from the shield shell or the pressing portion across a gap by the projecting end part contacting the shield shell or the pressing portion.

2. The connector of claim 1, wherein the bolt insertion tube portion includes a pair of the projecting end parts projecting from the body portion on both sides in the first direction, and the body portion is spaced apart from the shield shell and the pressing portion across the gaps by the pair of projecting end parts contacting the shield shell and the pressing portion.

3. The connector of claim 1, wherein:
the projecting end part of the bolt insertion tube portion projects with a projecting dimension of 0.5 mm or more from the body portion in the first direction.

4. The connector of claim 2, wherein:
the body portion of the wire holding portion includes a first holding portion and a second holding portion constituting the body portion by being assembled with each other while sandwiching and holding the wire from the both sides in the first direction,
a first recess to be held in contact with an outer peripheral surface of the wire by accommodating the wire is open in a contact surface of the first holding portion with the second holding portion,
a second recess to be held in contact with the outer peripheral surface of the wire by accommodating the wire is open in a contact surface of the second holding portion with the first holding portion,
the first and second recesses are connected to configure a wire through hole when the first and second holding portions are assembled,
the first holding portion includes a first bolt insertion tube portion penetrating through the first holding portion in the first direction and having a pair of the projecting end parts projecting on both sides in the first direction,
the second holding portion includes a second bolt insertion tube portion penetrating through the second holding portion in the first direction and having a pair of the projecting end parts projecting on both sides in the first direction, and
the pressing portion, the first bolt insertion tube portion, the second bolt insertion tube portion and the shield shell are successively overlapped in the first direction and fastened by the bolt.

5. The connector of claim 1, wherein the gap between the body portion and the shield shell or the pressing portion in the first direction is determined by Equation 1 below:
$$gap > ( a \times ( t 1 - t 2 ) \times c ) + ( b \times ( t 1 - t 2 ) \times d ) , \qquad ( Equation 1 )$$
in (Equation 1), a denotes a plate thickness of the first or second holding portion in the first direction, b denotes a plate thickness of the pressing portion or the shield shell in a part in contact with the first or second holding portion in the first direction, c denotes a linear expansion coefficient of a material of the first or second holding portion, d denotes a linear expansion coefficient of a material of the pressing portion or the shield shell, t1 denotes a heat resistant temperature of a coating of the wire, and t2 denotes a normal temperature (in a range of 5° C. to 35° C.).

6. The connector of claim 4, wherein:
the first recess of the first holding portion and the second recess of the second holding portion further extend in a projecting direction of the wire from the wire pull-out opening beyond the first and second bolt insertion tube portions, and
one and the other of the first and second holding portions on extending end sides of the first and second recesses are respectively provided with a resilient lock piece and a lock claw portion for coupling the first and second holding portions.

7. The connector of claim 6, wherein at least one of the first and second recesses is provided with wire pressing ribs at a plurality of positions spaced apart from each other in a circumferential direction.

8. The connector of claim 7, wherein at least one of the first and second recesses is provided with the plurality of wire pressing ribs provided at the plurality of positions spaced apart from each other in the circumferential direction and distributed at two positions spaced apart from each other in the axial direction of the wire.

9. The connector of claim 1, wherein a waterproof member for preventing water intrusion into the connector housing is externally fit on the wire, and the wire holding portion has a retainer function of hindering separation of the waterproof member to outside.
